(19) United States
(12) Patent Application Publication
(10) Pub. No.: US 2025/0210793 A1
(43) Pub. Date: Jun. 26, 2025

(54) Pressure Equalization Device

(71) Applicant: Illinois Tool Works Inc., Glenview, IL (US)

(72) Inventors: Eric Leverger, Beauchamp (FR); Maxence Trap, L’Isle Adam (FR)

(21) Appl. No.: 18/987,967

(22) Filed: Dec. 19, 2024

(30) Foreign Application Priority Data
Dec. 21, 2023 (EP) 23315484.8
Dec. 16, 2024 (FR) 2414214

(51) Int. Cl. H01M 50/325; F16K 17/16; H01M 50/30; H01M 50/342

(52) U.S. Cl. CPC H01M 50/325; H01M 50/394; F16K 17/16; H01M 50/3425

(57) ABSTRACT

The present disclosure relates to a pressure equalization device for a battery housing (1). The pressure equalization device includes a base (3) and a degassing valve (11) to move from a closed position to an open position to release overpressure inside the battery housing for emergency degassing. The pressure equalization device also includes a pressure equalization device (1) comprising a porous breathable membrane (9) that is permeable to gases and impermeable to liquids for the balance of pressure between an interior of the device (1) and an exterior of the device (1) when the degassing valve (11) is in the closed position. The degassing valve (11) and breathable membrane are decoupled.

### RELATED APPLICATIONS

The present application claims the benefit of European Patent Application No. 23315484.8, filed Dec. 21, 2023, and French Patent Application No. 2414214, filed Dec. 16, 2024, the contents of which are hereby incorporated by reference.

### BACKGROUND

The disclosure relates to a pressure equalization device. In particular, the disclosure relates to a pressure equalization device for a battery box, particularly in a vehicle.

Rechargeable batteries, particularly sealed designs such as lead-acid, nickel-metal hydride (NiMH), and lithium-ion, rely on pressure regulation mechanisms to ensure safe and efficient operation. During charging or discharging, these batteries can generate gases that increase internal pressure. Without proper regulation, this pressure buildup can lead to damage, leakage, or even catastrophic failure.

Pressure equalization devices are used to compensate for pressure variations inside a battery housing, releasing pressure in the event of overpressure. Pressure equalization devices usually have a degassing function used urgently in case of excessive pressure, and a breathing function used continuously to balance the internal battery pressure with local atmospheric pressure during normal operating conditions.

Patent document WO2023/218242A1 shows examples of pressure equalization device where a degassing valve includes a breathable membrane to perform both the breathing and degassing functions.

Battery valves address these challenges by allowing controlled gas release when internal pressure exceeds a predefined threshold while maintaining a sealed structure under normal operating conditions. In addition to ensuring safety, these valves help prevent contamination and, in some cases, enable gas recombination to minimize electrolyte loss. Despite existing solutions, there remains a need for improved valve designs that enhance safety, reliability, and adaptability across various battery applications.

### SUMMARY

The present disclosure relates generally to pressure equalization devices, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 shows a first example pressure equalization device, in perspective view from below.

FIG. 2 shows the pressure equalization device of FIG. 1 from below.

FIG. 3 shows the pressure equalization device of FIG. 1 in cross-sectional view from below.

FIG. 4 shows the pressure equalization device of FIG. 1 in cross-sectional view from the front.

FIG. 5 shows a second example pressure equalization device, in a perspective view from below.

FIG. 6 shows the pressure equalization device of FIG. 5 in cross-sectional view from below.

FIG. 7 shows the pressure equalization device of FIG. 5 in cross-sectional view from the front.

FIG. 8 shows the pressure equalization device of FIG. 5 in cross-sectional view from the front.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

An objective of the disclosure is to provide an alternative solution to known pressure equalization devices.

The disclosure concerns for example a pressure equalization device having degassing valve configured to release pressure from inside a battery housing to an exterior of the battery housing. The pressure equalization device may additionally comprise a breathable membrane for pressure permeable to gases and impermeable to liquids for the balance of pressure between an interior of the device and an exterior of the device when the degassing valve is closed.

According to a first aspect of the present disclosure there is provided a pressure equalization device for a battery housing, the pressure equalization device comprising a base, a degassing valve configured to move from a closed position to an open position to release overpressure inside the battery housing for emergency degassing, and a porous breathable membrane which is permeable to gases and impermeable to liquids for the balance of pressure between an interior of the device and an exterior of the device when the degassing valve is in the closed position, wherein the degassing valve and breathable membrane are decoupled. In other words, the breathable membrane may be physically dissociated from the degassing valve. That is, they are mounted separately within the pressure equalization device.

Advantageously, decoupling the breathable membrane from the degassing valve simplifies manufacturing and prevents faults with one component creating issues with the operation of the other component.

In examples, the base comprises a connector for connecting the base to the battery housing, in particular to an opening in the battery housing. The base may include a seal for sealing the pressure equalization device against the battery housing. In various examples, the connector may include any of a clip, a threaded connector, or fasteners (including screws, circlips and the like).

In examples, the base has a central cavity. The base and central cavity may be cylindrical, with a longitudinal axis.

In examples, the breathable membrane is mounted onto the base.

In examples, the breathable membrane is mounted inside a central cavity of said base. The base and central cavity may be cylindrical, with a longitudinal axis, and the breathable membrane may extend perpendicularly to the longitudinal axis. In examples, the base comprises at least one breathing conduct. In examples, the at least one breathing conduct is arranged to be in communication with the central cavity of the device when the degassing valve is in the closed position. The at least one breathing conduct may be arranged downstream the breathable membrane and upstream the degassing valve. In examples, the at least one breathing conduct is arranged to be in communication with the exterior of the device. In these examples, the base may be cylindrical and extend along a longitudinal axis and the one or more breathing conducts may extend substantially perpendicularly to the longitudinal axis.

In other examples, the base comprises at least one breathing conduct. The breathable membrane may be provided in or on the at least one breathing conduct. In examples, the at least one breathing conduct is arranged to be in communication with the central cavity of the device when the degassing valve is in the closed position. The at least one breathing conduct may be arranged upstream the degassing valve. In examples, the at least one breathing conduct is arranged to be in communication with the exterior of the device. In examples, the pressure equalization device comprises a plurality of breathing conducts and the membrane comprises or is made of a plurality of porous breathable membrane bodies. In these examples, the base may be cylindrical and extend along a longitudinal axis and the one or more breathing conducts may extend substantially perpendicularly to the longitudinal axis. The breathable membrane(s) may extend parallel to the longitudinal axis, across the breathing conduct(s).

In examples, a first of the plurality of breathing conducts is radially opposed to a second of the plurality of breathing conducts with respect to the longitudinal axis.

In this way the breathable membrane(s) can equalise pressure when the degassing valve is in the closed position.

In examples, each of the breathable membrane bodies have the same features as the membrane, for example being breathable and/or porous and/or permeable to gases and impermeable to liquids for the balance of pressure between an interior of the device and an exterior of the device when the degassing valve is in the closed position.

In examples, the breathable membrane is ultrasonically welded or soldered onto the base, or fixed by overmolding onto the base.

In examples, the pressure equalization device further comprises a lid covering the base.

In examples, the lid comprises a connector for connecting the lid to the base. In examples, connector is an interior connector inside the lid, for example a male or female clip, or a thread, cooperating with a corresponding clip, latch feature, or thread located on the base.

In examples, the degassing valve may comprise an umbrella valve. The umbrella valve may have a central spigot or shaft and an umbrella-shaped valve member extending therefrom. In examples, the degassing valve comprises an injected thermoplastic elastomer or is made of material comprising silicon.

In examples, the degassing valve is mounted to the base. In particular, the degassing valve may comprise a spigot or shaft that engages with an opening in the base for mounting the degassing valve. The opening in the base may be surrounded by one or more further openings. The further openings may be covered by the degassing valve in the closed position, and allow for passage of gas when the degassing valve is open. The further openings may be arranged to be in communication with the central cavity of the base. Alternatively, the opening may be shaped to permit gas flow through the opening when the spigot or shaft of the degassing valve is received therein and the degassing valve is in the open position. The base may define a valve seat, which may include a sealing member, against which the degassing valve seals in the closed position. When the degassing valve opens it may move away from the valve seat, in particular by elastic deformation, allowing gas to vent.

In other examples, the degassing valve may be mounted to the lid. The lid and/or the degassing valve may comprise a connector for connecting the degassing valve to the lid. In particular, the degassing valve may comprise a spigot or shaft that engages with an opening formed in the lid. The base may define a valve seat, for example within a central cavity in the base. The valve seat may include a sealing member against which the degassing valve seals when the lid (and degassing valve) are attached to the base and the degassing valve is in the closed position. One or more openings, preferably one opening, may be defined in the base to be closed by the degassing valve. The opening(s) may be arranged to be in communication with the central cavity. When the degassing valve opens it may move away from the valve seat, in particular by elastic deformation, allowing gas to vent through the one or more openings.

Advantageously, this arrangement creates more space within the base of the pressure equalization device because the spigot or shaft is mounted to the lid. This may allow increased degassing rate by releasing the volume below the degassing valve.

According to a second aspect of the present disclosure there is provided a pressure equalization device for a battery housing, the pressure equalization device comprising a base connectable to the battery housing, a lid connectable to the base, and a degassing valve configured to move from a closed position to an open position to release overpressure inside the battery housing for emergency degassing, wherein the base comprises a valve seat and wherein the degassing valve is mounted to the lid such that the degassing valve engages the valve seat when the lid is attached to the base. The second aspect of the disclosure may be combined with any features of the first aspect.

Optionally, the pressure equalization device further comprises a porous breathable membrane which is permeable to gases and impermeable to liquids for the balance of pressure between an interior of the battery housing and an exterior of the battery housing when the degassing valve is in the closed position.

Optionally, the degassing valve and breathable membrane are decoupled as described above. In other words, the breathable membrane may be physically dissociated from the degassing valve.

In examples, the base may include one or more breathing conducts, as described above, and the one or more breathable membrane bodies may be mounted in or on the breathing conduct(s).

In examples, the base comprises a connector for connecting the base to the battery housing, in particular to an opening in the battery housing.

The base may include a seal. In various examples, the connector may include any of a clip, a threaded connector, or fasteners (including screws, circlips and the like).

In examples, the breathable membrane is mounted onto the base.

In examples, the breathable membrane is mounted inside a central cavity of said base. In examples, the base extends cylindrically.

In examples, the breathable membrane is substantially perpendicular to the longitudinal axis of the base.

In examples, the base comprises at least one breathing conduct and the breathable membrane is provided in or on the at least one breathing conduct.

In examples, the at least one breathing conduct is arranged to be in communication with the interior of the device when the degassing valve is in the closed position. In this way the breathable membrane can equalise pressure when the degassing valve is in the closed position.

In examples, the pressure equalization device comprises a plurality of breathing conducts and the membrane comprises or is made of a plurality of breathable membrane bodies coupled within the plurality breathing conducts.

In examples, the base extends along a longitudinal axis and the one or more breathing conducts extend substantially perpendicularly to the longitudinal axis.

In examples, a first of the plurality of breathing conducts is radially opposed to a second of the plurality of breathing conducts with respect to the longitudinal axis.

In examples, the breathable membrane is ultrasonically welded or soldered onto the base, or fixed by overmolding onto the base.

In examples, the degassing valve comprises an injected thermoplastic elastomer or is made of material comprising silicon.

In examples, the lid comprises a connector for connecting the lid to the base. In examples, connector is an interior connector inside the lid, for example a male or female clip, or a thread, cooperating with a corresponding clip, latch feature, or thread located on the base.

In examples, the degassing valve may comprise an umbrella valve. The umbrella valve may have a central spigot or shaft and an umbrella-shaped sealing member extending therefrom.

In examples, the lid defines an interior chamber covering the base to protect it from environment, especially from water.

The lid may be substantially cylindrical, with an open end that receives the base and faces towards the battery housing in use.

The sides and opposite end of the lid may be closed to provide protection.

A vent opening may be defined by the open end of the lid, facing the battery housing in use, through which the exterior of the pressure equalization device is in communication with the degassing valve and the breathable membrane/membrane bodies.

In examples, the base and/or the lid may comprise an injected thermoplastic elastomer.

The present disclosure also provides following aspects:

In examples, the degassing valve and breathable membrane are decoupled.

In examples, the degassing valves and breathable membrane are provided on different parts of the pressure equalization device.

In examples, the pressure equalization device comprises a base.

In examples, the breathable membrane facilitates the balance of pressure between an interior of the device and an exterior of the device.

In examples, the breathable membrane is provided at the side of the pressure equalization device. In examples, the breathable membrane facilitates breathing from the sides of the pressure equalization device.

In examples, the breathable membrane is fixed by overmolding onto the pressure equalization device.

In examples, the breathable membrane is fixed by overmolding onto a base of the pressure equalization device.

In other examples, the breathable membrane is fixed by ultrasonic welding to the pressure equalization device. In examples, the breathable membrane is fixed by ultrasonic welding to a base of the pressure equalization device.

In examples, the breathable membrane is a porous membrane.

In examples, the breathable membrane is liquid impermeable.

In examples, the breathable membrane is gas permeable.

In examples, the breathable membrane is formed of a material comprising polytetrafluoroethylene (PTFE).

In examples, the breathable membrane is formed of a material comprising expanded polytetrafluoroethylene (ePTFE).

In examples, the pressure equalization device comprises a housing.

In examples, the housing defines an interior chamber.

In examples, the degassing valve is located in the housing.

In examples, the degassing valve is configured to release pressure from inside the housing to an exterior of the housing.

In examples, the housing and the base are provided at different portions of the equalization device.

In examples, the degassing valve is configured to release overpressure inside the housing for emergency degassing.

In examples, the degassing valve is an umbrella valve.

In examples, the degassing valve is made of a material comprising a thermoplastic elastomer (TPE).

In examples, the degassing valve is made of a material comprising 1k thermoplastic elastomer (TPE).

In other examples, the degassing valve is made of material comprising silicon.

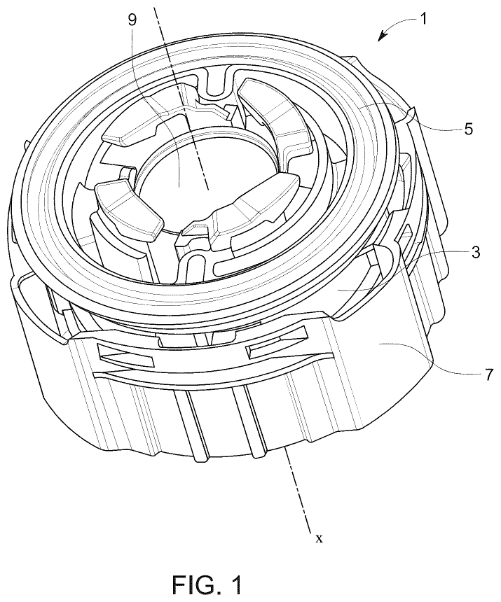

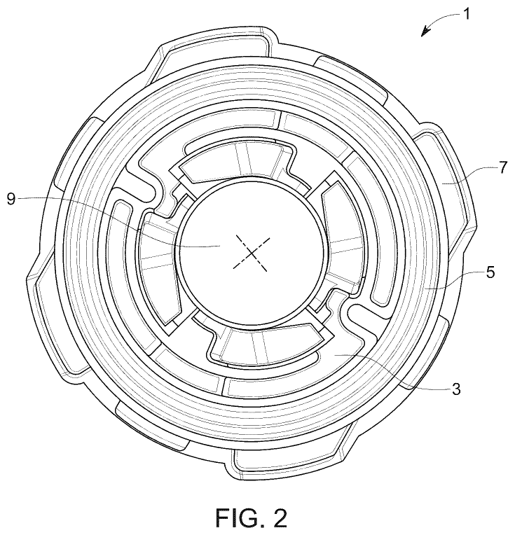

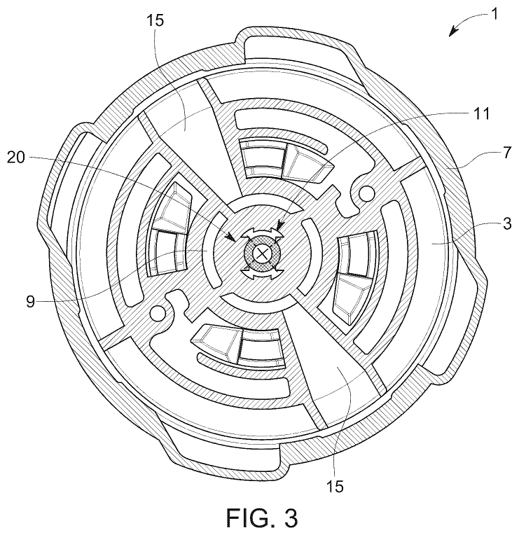

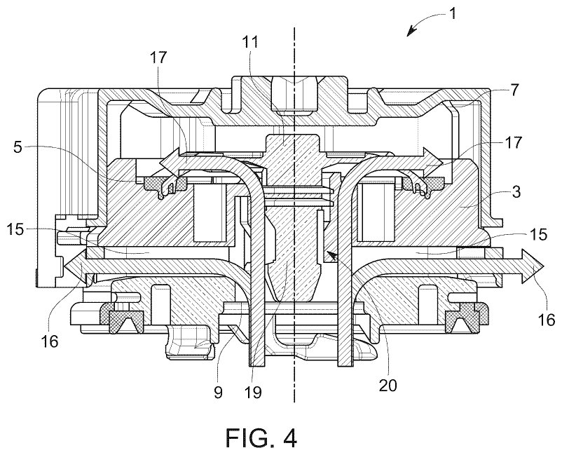

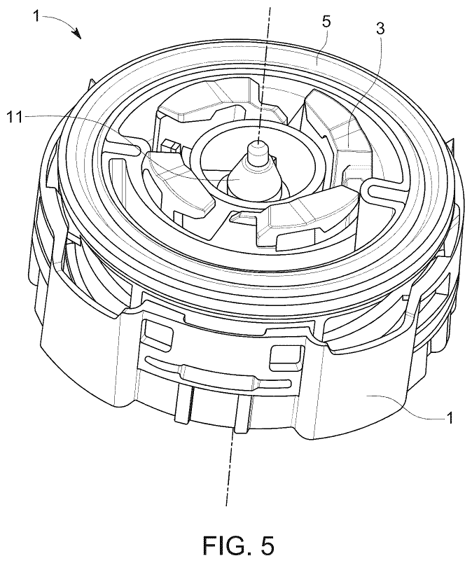

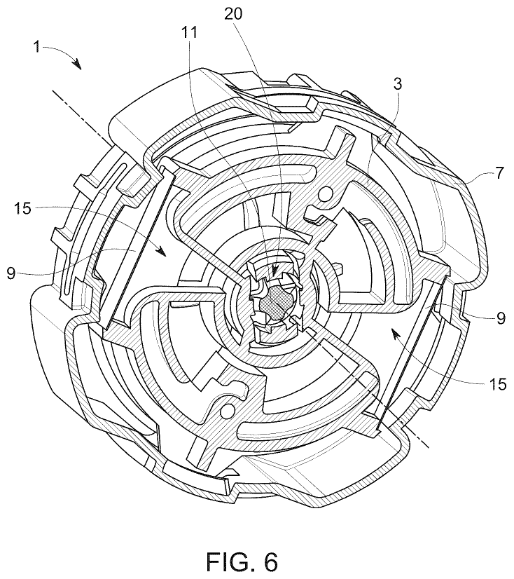

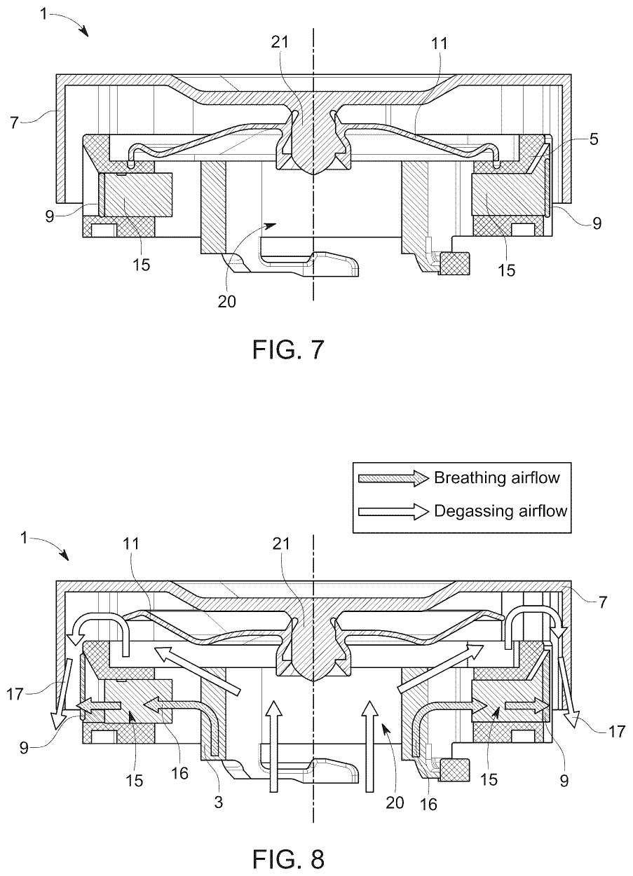

FIGS. 1 through 8 illustrate two examples of pressure equalization devices 1 from various perspectives. FIG. 1 provides a perspective view of the first pressure equalization device 1 from below, while FIG. 2 shows a direct bottom view of the same device. FIG. 3 presents a cross-sectional view of the first device from below, and FIG. 4 offers a cross-sectional view from the front. The second example of a pressure equalization device 1 is introduced in FIG. 5 with a perspective view from below. FIG. 6 shows a cross-sectional view of this second device from below, while FIGS. 7 and 8 present cross-sectional views of the second device from the front.

FIGS. 1 to 4 illustrate a first example pressure equalization device 1. In view of the foregoing, the pressure equalization device is suitable for a battery housing, and comprises a base 3, a degassing valve 11 configured to move from a closed position to an open position to release overpressure inside the battery housing for emergency degassing, and a porous breathable membrane 9 which is permeable to gases and impermeable to liquids for the balance of pressure between an interior of the device 1 and an exterior of the device 1 when the degassing valve 11 is in the closed position.

The degassing valve 11 and breathable membrane 9 are decoupled. In other words, the degassing valve 11 and breathable membrane 9 are separate or physically dissociated.

The base 3 of the pressure equalization device 1 extends along a longitudinal axis X and defines a fluid passage between an inlet and an outlet of said base 3. The base 3 is attachable to a battery housing, and in particular to an opening of a battery housing such that the interior of the battery housing is in fluid communication with the pressure equalization device 1. The base 3 has a central cavity 20 that extends from an inlet (where the base attaches to the battery housing) to one or more outlets.

The pressure equalization device 1 has a degassing valve 11. The degassing valve 11 is mounted on the base 3 and can move between a closed position and an open position. In this example the degassing valve 11 is an umbrella valve. The degassing valve 11 has a cylindrical spigot or shaft 19 and an umbrella valve member extending therefrom. The shaft 19 is mounted to the base 3 such that the umbrella valve member covers a passage through the base 3.

The base 3, in particular the central cavity 20, defines a central opening in which the spigot 19 is mounted, and one or more degassing openings that are arranged about the central opening to be covered by the degassing valve 11 in the closed position.

In examples, the degassing valve is made of a material comprising 1k thermoplastic elastomer (TPE). TPE or eTPE valves present significant elastic memory and opening ability in case of degassing, without plastic deformation.

In its closed position, the umbrella valve member of the degassing valve 11 sits against a degassing valve seat of the base 3, for example against a sealing member 5 placed on this degassing valve seat. In this position the degassing valve 11 seals the outlet. This is the normal operating condition of the pressure equalization device 1.

The degassing valve 11, in particular the umbrella valve member, is configured to elastically deform for degassing. In particular, in case of overpressure beyond a predetermined threshold within the battery housing, the pressure acting on the umbrella valve member causes it to be deformed and move away from the seat (sealing member 5), allowing degassing through the outlet.

Specifically, in the open position of the degassing valve 11, the outlet is not sealed by the degassing valve 11 and can create a degassing flow 17 by letting an overpressure gas from the inlet flow outside of the pressure equalization device 1 through the outlet, which allows the degassing from the inlet, i.e., from the vehicle battery box. Such an overpressure condition may occur due to thermal runaway of battery cells within the battery housing.

The degassing valve 11 serves only for degassing, having only this function, and no breathing function.

The pressure equalization device 1 also comprises a porous breathable membrane 9. The breathable membrane 9 is mounted at the inlet of the base 3. Specifically, the base 3 is extending cylindrically and the breathable membrane 9 is mounted inside the central cavity 20 within the base 3, at the inlet. In this way, all gas passing from the battery housing into the pressure equalization device 1 passes through the breathable membrane 9. The breathable membrane 9 is therefore arranged to extend perpendicularly to the longitudinal axis X. That is, the inlet extends parallel to the longitudinal axis X and the breathable membrane 9 extends across the inlet, perpendicularly to the longitudinal axis X.

In some examples the breathable membrane 9 is configured to break or rupture or dislodge in an overpressure situation, reducing gas flow restriction through the pressure equalization device 1. In some examples the breathable membrane 9 is configured to melt or disintegrate at a predetermined temperature, for example a temperature corresponding to thermal runaway on one or more battery cells in the battery housing.

As illustrated, the pressure equalization device 1 has at least one breathing conduct 15, particularly a plurality of breathing conducts 15. The breathing conducts 15 fluidly connect the interior of the battery housing with the exterior ambient pressure and therefore facilitate a breathing function of the pressure equalization device 1, even when the degassing valve 11 is in the closed position.

In this example, the breathing conducts 15 extend from a location within the base 3 between the degassing valve 11 and the breathable member 9 and thereby permit breathing gas flow when the degassing valve 11 is closed. The breathing conducts 15 extend laterally (sideways) relative to the longitudinal axis X, to a side of the base.

As described above, in the illustrated example the breathable member 9 is mounted to the base 3 at the inlet. However, in other examples, for example as illustrated in FIGS. 5 to 8, the breathable member 9 may be mounted in or on the breathing conducts 15. If a plurality of breathing conducts 15 are provided then a plurality of breathable membrane bodies 9 may be provided, one breathable membrane body 9 for each breathing conduct 15. In these examples the breathable membrane(s) 9 may extend in a direction parallel to the longitudinal axis X, extending across the laterally extending breathing conducts 15. The or each breathable membrane(s) 9 may close an outlet of the breathing conduct(s) 15.

The breathable membrane 9 is permeable to gases and impermeable to liquids. The breathable membrane 9 allows gas to pass through the breathable membrane 9 in order to equalize the pressure at the inlet i.e., inside the battery housing 1 with the ambient pressure outside the base 3. The breathable membrane 9 is always exposed to the internal pressure of the battery housing and the ambient pressure, so provides a breathing function illustrated as breathing flow 16.

The breathing flow 16 is a low volume flow, continuously present in normal operation, between the interior and exterior of the battery housing via the pressure equalization device 1. In this way, the breathing function does not affect the degassing function.

The breathable membrane 9 is for example a hydrophobic breathable membrane, which prevents liquids from entering the battery box. The breathable membrane 9 contains for example polytetrafluoroethylene (TPE) or expanded polytetrafluoroethylene (eTPE). The breathable membrane 9 therefore facilitates the balance of pressure between an interior of the device 1 and an exterior of the device 1 through the breathing flow 16.

As described above, in the example of FIGS. 1 to 4 the degassing valve 11 is mounted to the base 3. A lid 7 is mounted to the base 3 and covers the degassing valve 11. The lid 3 may be attached to the base 3 by a thread or clip or the like. The lid 3 and the base 3 are not fluid tight and openings are defined. The lid 7 has a generally cylindrical form, with an open side that faces the battery housing when attached to the base 3. The open side of the lid 7, optionally with cut-outs in the side wall of the lid 7, creates openings through which gas can pass to/from the breathable membrane 9 and the degassing valve 11 for breathing and degassing, respectively.

In the example of FIGS. 5 to 8 the degassing valve 11 is mounted to the lid 7. In particular, the degassing valve 11 has an opening and the lid 7 includes a connector in the form of a spigot 21 for mounting the degassing valve 11 to the lid 7. In alternative examples the degassing valve 11 may be connected to the lid 7 by clips or by welding or other attachment.

The body 3 has a central cavity 20 and a sealing surface (with seal 5), and the degassing valve 11 seals against the sealing surface when the lid 7 is attached to the base 3, as shown in FIG. 7.

Preferably, the degassing valve 11 comprises an injected thermoplastic elastomer or is made of material comprising silicon. In other examples, the degassing valve 11 is made of material comprising silicon.

In this example, the breathing conducts 15 extend laterally from the central cavity in the same way as described above with reference to the example of FIGS. 1 to 4. In this example, the pressure equalization 1 includes breathable membrane bodies 9 provided in or on each of the breathing conducts 15, specifically at the outlets of the breathing conducts 15. Alternatively, as in the example of FIGS. 1 to 4, the breathable membrane 9 may be provided in the central cavity 20, at the inlet.

In the example of FIGS. 5 to 8, the central cavity 20 extends parallel to the longitudinal axis X. The breathing conducts 15 extend laterally to a side surface of the body 3. Specifically, the base 3 is generally cylindrical and the breathing conducts 15 extend perpendicularly to the longitudinal axis X to a surface of the body 3. As illustrated, a first of the breathing conducts 15 may be radially opposed to a second of the breathing conducts 15 with respect to the longitudinal axis X.

The lid 7 is attachable to the base 3, for example the lid 7 is screwed or clipped onto the base 3. The lid 7 has a generally cylindrical form with an open side that faces the battery housing in use. Openings are provided within the open side of the lid (and/or in a side wall of the lid 7) for gas passage during breathing and degassing. Specifically, when the lid 7 is attached to the base 3 it is spaced from the ends of the breathing conducts 15 and a fluid path is defined from the degassing valve to the exterior, as illustrated as degassing flow 17 in FIG. 8.

In this example, the breathable membrane 9 (or membrane bodies 9) are disposed on or in the breathing conducts and extend substantially perpendicularly to the longitudinal axis X. As illustrated, the breathable membrane 9 (or membrane bodies 9) are mounted at the ends of the breathing conduct(s) 15. The breathable membrane 9 (or membrane bodies 9) cover the breathing conduct(s) 15. The breathable membrane 9 (or membrane bodies 9) are attached to the base 3 to close the outlets of the breathing conduct(s) 15. The breathable membrane 9 (or membrane bodies 9) may be ultrasonically welded or soldered onto the base 3. Alternatively, the breathable membrane 9 may be overmolded or co-moulded with the base 3.

As shown, two breathing conducts 15 are radially opposed with respect to the longitudinal axis X and each has one breathable membrane body 9. Further breathing conducts 15 may be provided, for example there may be three, four, five or more breathing conducts 15.

FIG. 7 illustrates the pressure equalization device 1 in its closed position, wherein the degassing valve 11 is not engaging the degassing function, as the pressure threshold is not met on the inlet side of the degassing valve 11.

FIG. 8 illustrates the pressure equalization device 1 in its open (degassing) position, wherein the internal pressure of the battery housing has deformed the degassing valve 11 such that the umbrella valve member has moved away from the seat providing a passage for degassing flow 17.

The example of FIGS. 5 to 8 advantageously increases the volume of the central cavity 20 within the base 3 because the degassing valve shaft 19 is located within the lid 7. This provides increased degassing rates because the opening covered by the degassing valve 11 is larger, providing a larger opening when the degassing valve 11 is deformed.

In summary, the pressure equalization device 1 includes a degassing valve 11 that releases pressure in the event of overpressure (i.e., emergency degassing), and includes a breathable membrane 9 that is separate from the degassing valve 11 and facilitates the balance of pressure between an interior of the device 1 and an exterior of the device 1.

Thus, the functions of emergency degassing and pressure balancing are provided by (i.e., at) separate parts of the pressure equalization device that are decoupled from one another.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE SIGNS

1 pressure equalization device
3 base
5 sealing member
7 lid
9 breathable membrane
11 degassing valve
15 breathing conducts
16 breathing flow
17 degassing flow
19 degassing valve shaft
20 central cavity
21 connector
X longitudinal axis

What is claimed is:

1. A pressure equalization device for a battery housing (1), the pressure equalization device comprising:
a base (3);
a degassing valve (11) configured to move from a closed position to an open position to release overpressure inside the battery housing for emergency degassing; and
a porous breathable membrane (9) that is permeable to gases and impermeable to liquids for the balance of pressure between an interior of the pressure equalization device (1) and an exterior of the pressure equalization device (1) when the degassing valve (11) is in the closed position,
wherein the degassing valve (11) and breathable membrane (9) are decoupled.

2. The pressure equalization device (1) according to claim 1, wherein the breathable membrane (9) is mounted onto the base (3).

3. The pressure equalization device (1) according to claim 2, wherein the breathable membrane (9) is mounted inside a central cavity (20) of said base (3).

4. The pressure equalization device (1) according to claim 1,
wherein the base (3) comprises at least one breathing conduct (15) and the breathable membrane is provided in or on the at least one breathing conduct (15), and
wherein the at least one breathing conduct (15) is arranged to be in communication with a central cavity of the pressure equalization device (1) when the degassing valve (11) is in the closed position.

5. The pressure equalization device (1) according to claim 4, comprising a plurality of breathing conducts (15), the membrane comprising or being made of a plurality of breathable membrane bodies (9).

6. The pressure equalization device (1) according to claim 5, wherein the base (3) extends along a longitudinal axis (X) and the breathing conducts (15) extend perpendicularly to the longitudinal axis (X).

7. The pressure equalization device (1) according to claim 6, wherein a first of the plurality of breathing conducts (15) is radially opposed to a second of the plurality of breathing conducts (15) with respect to the longitudinal axis (X).

8. The pressure equalization device (1) according to claim 1, wherein the breathable membrane (9) is ultrasonically welded or soldered onto the base (3).

9. The pressure equalization device (1) according to claim 1, wherein the breathable membrane (9) is overmolded onto the base (3).

10. The pressure equalization device (1) according to claim 1, wherein the degassing valve (11) comprises an injected thermoplastic elastomer or is made of material comprising silicon.

11. The pressure equalization device (1) according to claim 1, further comprising a lid (7) covering the base (3).

12. The pressure equalization device (1) according to claim 10, wherein the degassing valve (11) in mounted on the lid (7).
